(19) United States
(12) Patent Application Publication
(10) Pub. No.: US 2024/0161436 A1
(43) Pub. Date: May 16, 2024

(54) COMPACT LIDAR REPRESENTATION

(71) Applicant: WAABI Innovation Inc., Toronto (CA)

(72) Inventors: Yuwen XIONG, Toronto (CA); Wei-Chiu MA, Cambridge, MA (US); Jingkang WANG, Toronto (CA); Raquel URTASUN, Toronto (CA)

(21) Appl. No.: 18/506,668

(22) Filed: Nov. 10, 2023

Related U.S. Application Data
(60) Provisional application No. 63/424,860, filed on Nov. 11, 2022.

(51) Int. Cl. G06T 19/20; G06T 5/00; G06T 5/20; G06T 9/00

(52) U.S. Cl. CPC G06T 19/20; G06T 5/002; G06T 5/20; G06T 9/00; G06T 2207/10028; G06T 2207/20081; G06T 2207/30181; G06T 2210/56; G06T 2219/2016

(57) ABSTRACT

Compact LiDAR representation includes performing operations that include generating a three-dimensional (3D) LiDAR image from LiDAR input data, encoding, by an encoder model, the 3D LiDAR image to a continuous embedding in continuous space, and performing, using a code map, a vector quantization of the continuous embedding to generate a discrete embedding. The operations further include decoding, by the decoder model, the discrete embedding to generate modified LiDAR data, and outputting the modified LiDAR data.

### CROSS-REFERENCE TO RELATED APPLICATIONS

This application is a non-provisional application of, and thereby claims benefit to U.S. Patent Application Ser. No. 63/424,860 filed on Nov. 11, 2022, which is incorporated herein by reference in its entirety.

### BACKGROUND

LiDAR, which stands for Light Detection and Ranging, is a remote sensing method that uses light in the form of a pulsed laser to measure ranges (variable distances) to various objects. LiDAR provides accurate geometric measurements of the three-dimensional (3D) world. Unfortunately, dense LiDARs are very expensive, and the point clouds captured by low-beam LiDAR are often sparse.

LiDAR is used in semi-autonomous and fully autonomous systems. For example, to effectively perceive an autonomous system's surroundings, existing autonomous systems primarily exploit LiDAR as the major sensing modality, since the autonomous system can capture well the 3D geometry of the world. However, while LiDAR provides accurate geometric measurements, LiDAR data is sparse and can be difficult to scale up.

With regards to sparsity, many LiDARs are time-of-flight and scan the environment by rotating emitter-detector pairs (e.g., beams) around the azimuth. At every time step, each emitter emits a light pulse which travels until the beam hits a target, gets reflected, and is received by the detector. Distance is measured by calculating the time of travel. Due to the design, the captured point cloud density inherently decreases as the distance to the sensor increases. For distant objects, often only a few LiDAR points are captured, which greatly increases the difficulty for 3D perception. Poor weather conditions and fewer beams increase the sparsity problem.

Further, training and testing perception systems in diverse situations are crucial for developing robust autonomous systems. However, due to their intricate design, LiDARs are much more expensive than cameras. The price barrier makes LiDAR less accessible to the general public and restricts data collection to a small fraction of vehicles that populate our roads, significantly hindering scaling up.

Additionally, LiDAR simulation is often performed by manually creating the scene or relying on multiple scans of the real world in advance, making such a solution less desirable.

### SUMMARY

In general, in one aspect, one or more embodiments relate to a method that includes generating a three-dimensional (3D) LiDAR image from LiDAR input data, encoding, by an encoder model, the 3D LiDAR image to a continuous embedding in continuous space, and performing, using a code map, a vector quantization of the continuous embedding to generate a discrete embedding. The method further includes decoding, by the decoder model, the discrete embedding to generate modified LiDAR data, and outputting the modified LiDAR data.

In general, in one aspect, one or more embodiments relate to a system that includes one or more computer processors and a non-transitory computer readable medium comprising computer readable program code for causing the one or more computer processors to perform operations. The operations include generating a three-dimensional (3D) LiDAR image from LiDAR input data, encoding, by an encoder model, the 3D LiDAR image to a continuous embedding in continuous space, and performing, using a code map, a vector quantization of the continuous embedding to generate a discrete embedding. The operations further include decoding, by the decoder model, the discrete embedding to generate modified LiDAR data, and outputting the modified LiDAR data.

In general, in one aspect, one or more embodiments relate to a non-transitory computer readable medium comprising computer readable program code for causing a computer system to perform operations. The operations include generating a three-dimensional (3D) LiDAR image from LiDAR input data, encoding, by an encoder model, the 3D LiDAR image to a continuous embedding in continuous space, and performing, using a code map, a vector quantization of the continuous embedding to generate a discrete embedding. The operations further include decoding, by the decoder model, the discrete embedding to generate modified LiDAR data, and outputting the modified LiDAR data.

Other aspects of the invention will be apparent from the following description and the appended claims.

### BRIEF DESCRIPTION OF DRAWINGS

FIG. 1 shows an autonomous system with a virtual driver in accordance with one or more embodiments.

FIG. 2 shows a simulation environment for training a virtual driver of an autonomous system in accordance with one or more embodiments of the invention.

FIG. 3 shows a LiDAR modification system in accordance with one or more embodiments of the invention.

FIG. 4 shows a diagram of a three-dimensional LiDAR image in accordance with one or more embodiments of the invention.

FIG. 5 shows a flowchart for manipulating LiDAR data using a LiDAR modification system in accordance with one or more embodiments of the invention.

FIG. 6 shows a flowchart for training the LiDAR modification system in accordance with one or more embodiments of the invention.

FIGS. 7A, 7B, 7C, and 7D show example LiDAR modifications in accordance with one or more embodiments.

FIGS. 8A and 8B show a computing system in accordance with one or more embodiments of the invention.

Like elements in the various figures are denoted by like reference numerals for consistency.

### DETAILED DESCRIPTION

One or more embodiments are directed to a LiDAR manipulation system. The LiDAR manipulation system is a machine learning framework that includes multiple machine learning models. The LiDAR manipulation system includes an encoder model that encodes a three-dimensional (3D) LiDAR map into a continuous embedding, vector quantization processing using a code map that transforms the continuous embedding into a discrete embedding, and a decoder model that decodes the discrete embedding.

From a higher level, one or more are able to provide scene-level LiDAR completion, LiDAR generation, and LiDAR manipulation. Specifically, the transformation of the vector quantization using the code map creates a compact, discrete representation that encodes the LiDAR data's geometric structure, is robust to noise, and is easy to manipulate.

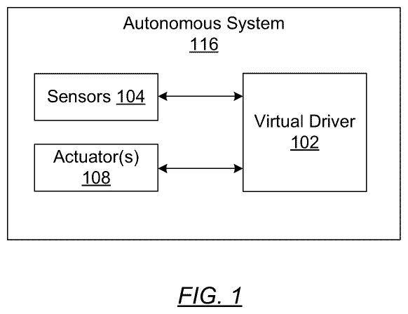

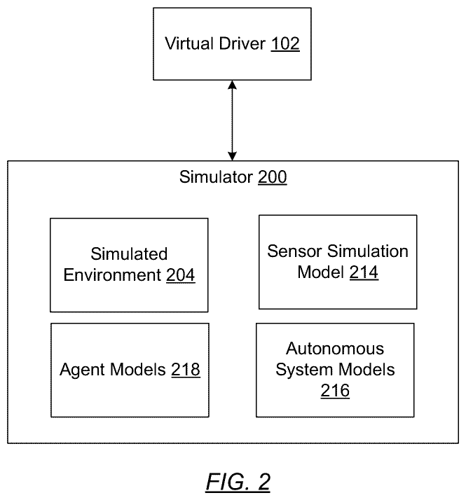

One or more embodiments may be used to generate and manage LiDAR used by autonomous systems or in the testing and training of autonomous systems. Turning to the Figures, FIGS. 1 and 2 show example diagrams of the autonomous system and virtual driver. Turning to FIG. 1, an autonomous system (116) is a self-driving mode of transportation that does not require, but may use, a human pilot or human driver to move and react to the real-world environment. The autonomous system (116) may be completely autonomous or semi-autonomous. As a mode of transportation, the autonomous system (116) is contained in a housing configured to move through a real-world environment. Examples of autonomous systems include self-driving vehicles (e.g., self-driving trucks and cars), drones, airplanes, robots, etc.

The autonomous system (116) includes a virtual driver (102) which is the decision-making portion of the autonomous system (116). The virtual driver (102) is an artificial intelligence system that learns how to interact in the real world and interacts accordingly. The virtual driver (102) is the software executing on a processor that makes decisions and causes the autonomous system (116) to interact with the real-world including moving, signaling, and stopping or maintaining a current state. Specifically, the virtual driver (102) is decision making software that executes on hardware (not shown). The hardware may include a hardware processor, memory or other storage device, and one or more interfaces. A hardware processor is any hardware processing unit that is configured to process computer readable program code and perform the operations set forth in the computer readable program code.

A real-world environment is the portion of the real world through which the autonomous system (116), when trained, is designed to move. Thus, the real-world environment may include concrete and land, construction, and other objects in a geographic region along with agents. The agents are the other agents in the real-world environment that are capable of moving through the real-world environment. Agents may have independent decision-making functionality. The independent decision-making functionality of the agent may dictate how the agent moves through the environment and may be based on visual or tactile cues from the real-world environment. For example, agents may include other autonomous and non-autonomous transportation systems (e.g., other vehicles, bicyclists, robots), pedestrians, animals, etc.

In the real world, the geographic region is an actual region within the real-world that surrounds the autonomous system. Namely, from the perspective of the virtual driver, the geographic region is the region through which the autonomous system moves. The geographic region includes agents and map elements that are located in the real world. Namely, the agents and map elements each have a physical location in the geographic region that denotes a place in which the corresponding agent or map element is located. The map elements are stationary in the geographic region, whereas the agents may be stationary or nonstationary in the geographic region. The map elements are the elements shown in a map (e.g., road map, traffic map, etc.) or derived from a map of the geographic region.

The real-world environment changes as the autonomous system (116) moves through the real-world environment. For example, the geographic region may change, and the agents may move positions, including new agents being added and existing agents leaving.

In order to interact with the real-world environment, the autonomous system (116) includes various types of sensors (104), such as LiDAR sensors amongst other types, which are used to obtain measurements of the real-world environment, and cameras that capture images from the real-world environment. LiDAR (i.e., the acronym for “light detection and ranging”) is a sensing technique that uses light in the form of a pulsed laser to measure ranges (variable distances) of various objects in an environment. The autonomous system (116) may include other types of sensors as well. The sensors (104) provide input to the virtual driver (102).

In addition to sensors (104), the autonomous system (116) includes one or more actuators (108). An actuator is hardware and/or software that is configured to control one or more physical parts of the autonomous system based on a control signal from the virtual driver (102). In one or more embodiments, the control signal specifies an action for the autonomous system (e.g., turn on the blinker, apply breaks by a defined amount, apply accelerator by a defined amount, turn the steering wheel or tires by a defined amount, etc.). The actuator(s) (108) are configured to implement the action. In one or more embodiments, the control signal may specify a new state of the autonomous system and the actuator may be configured to implement the new state to cause the autonomous system to be in the new state. For example, the control signal may specify that the autonomous system should turn by a certain amount while accelerating at a predefined rate, while the actuator determines and causes the wheel movements and the amount of acceleration on the accelerator to achieve a certain amount of turn and acceleration rate.

The testing and training of the virtual driver (102) of the autonomous systems in the real-world environment is unsafe because of the accidents that an untrained virtual driver can cause. Thus, as shown in FIG. 2, a simulator (200) is configured to train and test a virtual driver (102) of an autonomous system. For example, the simulator may be a unified, modular, mixed-reality, closed-loop simulator for autonomous systems. The simulator (200) is a configurable simulation framework that enables not only evaluation of different autonomy components of the virtual driver (102) in isolation, but also as a complete system in a closed-loop manner The simulator reconstructs “digital twins” of real-world scenarios automatically, enabling accurate evaluation of the virtual driver at scale. The simulator (200) creates the simulated environment (204) which is a virtual world in which the virtual driver (102) is a player in the virtual world. The simulated environment (204) is a simulation of a real-world environment, which may or may not be in actual existence, in which the autonomous system is designed to move. As such, the simulated environment (204) includes a simulation of the objects (i.e., simulated objects or agents) and background in the real world, including the natural objects, construction, buildings and roads, obstacles, as well as other autonomous and non-autonomous objects. The simulated environment simulates the environmental conditions within which the autonomous system may be deployed. The simulated objects may include both stationary and non-stationary objects. Non-stationary objects are agents in the real-world environment.

In the simulated environment, the geographic region is a realistic representation of a real-world region that may or may not be in actual existence. Namely, from the perspective of the virtual driver, the geographic region appears the same as if the geographic region were in existence if the geographic region does not actually exist, or the same as the actual geographic region present in the real world. The geographic region in the simulated environment includes virtual agents and virtual map elements that would be actual agents and actual map elements in the real world. Namely, the virtual agents and virtual map elements each have a physical location in the geographic region that denotes an exact spot or place in which the corresponding agent or map element is located. The map elements are stationary in the geographic region, whereas the agents may be stationary or nonstationary in the geographic region. As with the real-world, a map exists of the geographic region that specifies the physical locations of the map elements.

The simulator (200) includes an autonomous system model (216), sensor simulation models (214), and agent models (218). The autonomous system model (216) is a detailed model of the autonomous system in which the virtual driver (102) will execute. The autonomous system model (216) includes model, geometry, physical parameters (e.g., mass distribution, points of significance), engine parameters, sensor locations and type, and the firing pattern of the sensors, information about the hardware on which the virtual driver executes (e.g., processor power, amount of memory, and other hardware information), and other information about the autonomous system. The various parameters of the autonomous system model may be configurable by the user or another system.

The autonomous system model (216) includes an autonomous system dynamic model. The autonomous system dynamic model is used for dynamics simulation that takes the actuation actions of the virtual driver (e.g., steering angle, desired acceleration) and enacts the actuation actions on the autonomous system in the simulated environment to update the simulated environment and the state of the autonomous system. The interface between the virtual driver (102) and the simulator (200) may match the interface between the virtual driver (102) and the autonomous system in the real world. Thus, to the virtual driver (102), the simulator simulates the experience of the virtual driver within the autonomous system in the real world.

In one or more embodiments, the sensor simulation model (214) models, in the simulated environment, active and passive sensor inputs. The sensor simulation models (114) are configured to simulate the sensor observations of the surrounding scene in the simulated environment (204) at each time step according to the sensor configuration on the vehicle platform. Passive sensor inputs capture the visual appearance of the simulated environment including stationary and nonstationary simulated objects from the perspective of one or more cameras based on the simulated position of the camera(s) within the simulated environment. Examples of passive sensor inputs include inertial measurement unit (IMU) and thermal. Active sensor inputs are inputs to the virtual driver of the autonomous system from the active sensors, such as LiDAR, RADAR, global positioning system (GPS), ultrasound, etc. Namely, the active sensor inputs include the measurements taken by the sensors, and the measurements being simulated based on the simulated environment based on the simulated position of the sensor(s) within the simulated environment. Thus, the sensor simulation model (214) is configured to simulate LiDAR sensor input to the virtual driver.

Agent models (218) each represent an agent in a scenario. An agent is a sentient being that has an independent decision-making process. Namely, in the real world, the agent may be an animate being (e.g., a person or an animal) that makes a decision based on an environment. The agent makes active movement rather than or in addition to passive movement. An agent model, or an instance of an actor model may exist for each agent in a scenario. The agent model is a model of the agent. If the agent is in a mode of transportation, then the agent model includes the model of transportation in which the agent is located. For example, actor models may represent pedestrians, children, vehicles being driven by drivers, pets, bicycles, and other types of actors.

The simulator with the sensor simulation model, and/or the virtual driver of the autonomous system may include a LiDAR modification system. However, the LiDAR modification system may be used outside of the technological environment of the autonomous system. For example, the LiDAR modification system may be used in conjunction with virtually any system that uses LiDAR data.

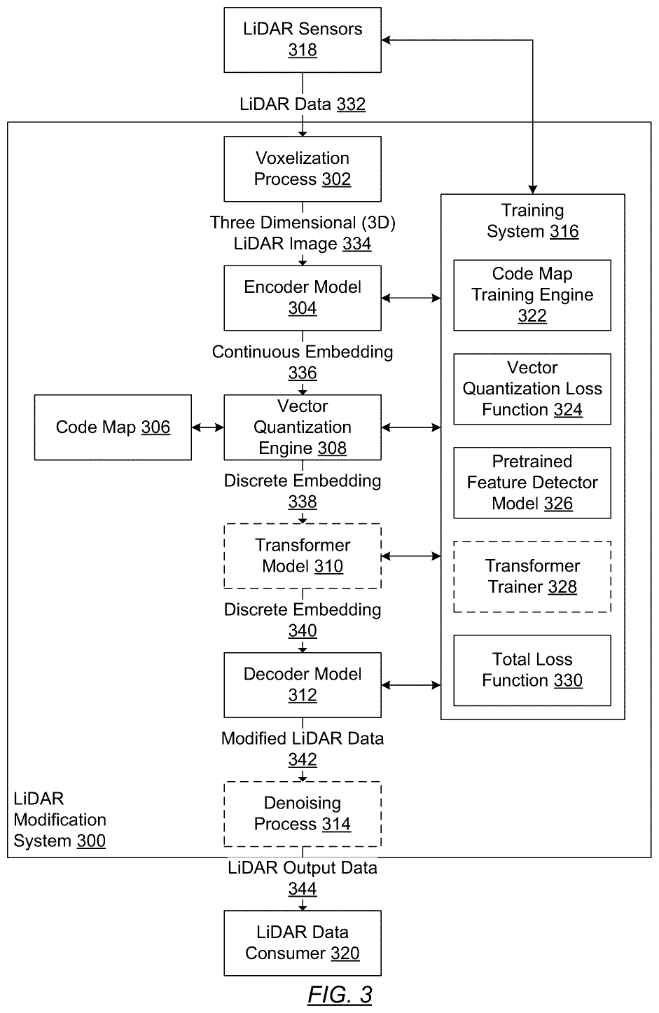

FIG. 3 shows a schematic diagram of a LiDAR modification system (300). The LiDAR modification system (300) is a machine learning framework that is configured to modify LiDAR data from LiDAR sensors (318). For example, the LiDAR modification system (300) may be configured to transform sparse LiDAR data to dense LiDAR data, add actors, generate new LiDAR data, and perform other actions.

The LiDAR sensors (318) are virtual or real LiDAR sensors. The LiDAR sensors (318) are configured to provide LiDAR data to the LiDAR modification system. The LiDAR sensors (318) may include virtual LiDAR sensors as described above with reference to FIG. 2 or real LiDAR sensors as described above with reference to FIG. 1. In one or more embodiments, the LiDAR sensors include all or part of the sensor simulation model for LiDAR as described in FIG. 2 for the purposes of training the LiDAR modification system (300).

The output of the LiDAR modification system (300) is to a LiDAR data consumer (320). The LiDAR data consumer (320) is a user of the modified LiDAR data to perform an operation. When the LiDAR modification system is used in conjunction with the testing, training, and/or use of an autonomous system, the LiDAR data consumer (320) may be the simulator described above in reference to FIG. 2 or the virtual driver, or another component of the simulator or virtual driver. In such an example, the simulator may use the LiDAR data to generate a new scene to train a virtual driver or the virtual driver may use the modified LiDAR data to detect actors in a scene.

As shown in FIG. 3, the LiDAR modification system (300) may include a voxelization process (302), an encoder model (304), a code map (306), a vector quantization engine (308), a transformer model (310), a decoder model (312), a denoising process (314), and a training system (316). The training system (316) includes a code map training engine (322), a vector quantization loss function (324), a pretrained feature detector model (326), a transformer trainer (328), and a total loss function (330). Each of these components is described below.

The voxelization process (302) is configured to obtain, as input, LiDAR data (332) and generate, as output, a 3D LiDAR image (334). The LiDAR data, when received, is a list of LiDAR points. The LiDAR points may each have a distance, direction, and intensity. The voxelization process (302) is a software process that is configured to determine, for each LiDAR point in the list, the location of the LiDAR point in a 3D grid of the geographic region that forms the 3D LiDAR image (334).

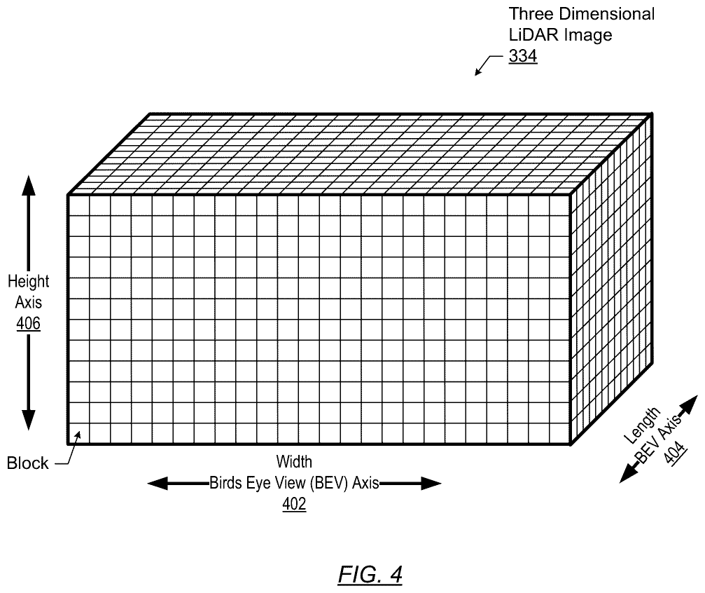

FIG. 4 shows a diagram of the 3D LiDAR image 334. Turning briefly to FIG. 4, the 3D LiDAR image (334) is a grid having three axes in one or more embodiments. The first two axes are a width birds eye view (BEV) axis (402) and a length BEV axis (404). The width birds eye view (BEV) axis (402) and the length BEV axis (404) are axes that may be parallel to the ground. There might be some pitch angle, curvature, etc. that means the BEV is not directly parallel to ground. The third axis is perpendicular to the width and length axis. The third axis is a height axis (406) that corresponds to elevation from the Earth. For example, the width and length axis may be substantively planar to the longitudinal and latitudinal axes while the third axis is parallel to the elevation axis and corresponds to elevation. Thus, the 3D LiDAR image (334) is a grid model of the geographic region whereby a one-to-one mapping exists between blocks in the grid and subregions of the geographic region, and the location of the block with respect to the grid defines the corresponding subregion in the geographic region to which the block refers. Accordingly, locations in the geographic region are deemed to be mapped to a particular block of the 3D LiDAR image when the location is in a subregion that is mapped to or referenced by the block.

The size of the subregion is dependent on and defined by the resolution of the 3D LiDAR image (334). In one or more embodiments, the resolution of the 3D LiDAR image (334) is configurable and may or may not match the resolution of the LiDAR points. For example, multiple LiDAR points may be mapped to the same block of the 3D LiDAR image (334)

The 3D LiDAR image (334) may be a binary grid. For example, in the binary grid, blocks in the grid have one if at least one LiDAR point references a location in the subregion mapped to the block and zero otherwise. The set values of the blocks in the binary grid is a hyperparameter. In some implementations, the blocks in the binary grid may be set to other values, such as greater than one to avoid noise, if at least one LiDAR point references a location in the subregion mapped to the block Further, the 3D LiDAR image may be a sparse grid. A sparse grid is a grid in which most of the values of the grid are zero. Nonbinary grids may be used without departing from the scope of the claims.

Returning to FIG. 3, the 3D LiDAR grid (334) is used as input to an encoder model (304). The encoder model (304) is a machine learning model that is configured to generate a continuous embedding (336) from the 3D LiDAR image (334). Specifically, the encoder model (304) is configured to learn the embedding. An embedding, or vector embedding, is an encoding of semantic information that is in the 3D LiDAR image. The embedding is continuous in that the values of the embedding are in continuous space. For example, subject to precision defined by the number of bits, any rational number may be represented by the vector embedding in one or more embodiments.

The vector quantization engine (308) is a software process configured to perform a vector quantization process on the continuous embedding (336) to generate a discrete embedding (338). The discrete embedding (338) is a vector embedding that is in discrete space. Namely, the possible values of the discrete embedding (338) are orders of magnitude less than the possible values of the continuous embedding (336). A vector quantization process is a mapping process from continuous embedding to a finite set of values (i.e., codes). The vector quantization process uses a code map (306) that is trained. The code map (306) is a mapping between the codes and the continuous space. In one or more embodiments, the mapping by the code map is learned through machine learning.

The output of the vector quantization engine (308) is a discrete embedding (338) that may be optionally used by a transformer model (310) or directly by a decoder model (312). A transformer model (310) may be used in one or more embodiments to change the scene captured by the LiDAR data. For example, the transformer model may add or remove actors, generate different scenes, or perform other actions by modifying or predicting the codes in the discrete embedding. The transformer model (310) is shown as optional with dashed lines because when performing certain types of LiDAR modifications, the transformer model may be excluded. For example, when performing a sparse to dense LiDAR modification, the LiDAR modification system may exclude the transformer model (310).

Continuing with FIG. 3, the decoder model (312) is a machine learning model that takes, as input, the discrete embedding (340) and generates, as output, modified LiDAR data (342). In one or more embodiments, the modified LiDAR data is a 3D LiDAR image as described above with reference to FIG. 4. However, the points in the modified LiDAR data are in different locations than in the 3D LiDAR image (334) that is input to the encoder model (304). For example, more points may be in the modified LiDAR data (342) than in the 3D LiDAR image (334) if the LiDAR modification system performs sparse to dense conversion. As another example, points may be in modified positions if the actors of a scene are removed or in different locations to simulate that real LiDAR beams would bounce off of the actors at the different locations. Regardless of the modification, the points that are for reflections off of the same object may be in different locations due to the encoding, mapping, and decoding processes.

In one or more embodiments, the modified LiDAR data (342) may be passed through an optional denoising process (314). A denoising process (314) is a software process that removes LiDAR points that could not exist in the real world (i.e., noise). The LiDAR points that do not exist in the real world include LiDAR points that would be obfuscated by other objects in the scene. In particular, a LiDAR sensor captures the LiDAR data from one or more particular perspectives. If the beam could not reflect off of all or a portion of the object in the particular perspective(s), then no LiDAR data points should exist for the object or portion thereof. The output of the denoising process (314) and of the LiDAR modification system (300) is LiDAR output data (344). If no denoising process is used, then the LiDAR output data (344) may be the same as the modified LiDAR data (342) that is output by the decoder model.

As discussed above, various components of the LiDAR modification system (300) are trained through an iterative machine learning training process. The training system (316) is configured to train the components of the LiDAR modification system (300). The training system (316) includes a code map training engine (322), a vector quantization loss function (324), a pretrained feature detector model (326), a transformer trainer (328), and a total loss function (330). Each of these components is described below.

The code map training engine (322) is configured to train the code map (306). Specifically, the code map training engine (322) is configured to train the mapping between continuous space and codes. Further, the code map training engine (322) is configured to detect codes that fail to satisfy a utilization threshold for being used. For example, codes that fail to satisfy a utilization threshold are codes that have not been referenced within the threshold amount of time or are mapped to a small set of continuous space embeddings. Such codes may be referred to as “dead codes.” The code map training engine (322) is configured to remap the dead codes.

In one or more embodiments, a multiphase training process is performed. In the first training stage, the components of the LiDAR modification system (300) are trained to generate an output that is substantively the same as the input (e.g., dense LiDAR). In the second stage, certain models may be frozen while other models are trained.

The vector quantization loss function (124) is configured to calculate a vector quantization loss. In one or more embodiments, the vector quantization loss calculates a binary cross entropy loss between the modified LiDAR data (342) and the 3D LiDAR data (334). The vector quantization loss may also include a term that compares codes generated using vector embeddings of the training input 3D LiDAR image and codes generated using vector embeddings of the training output 3D LiDAR image.

The pretrained feature detector model (326) is a machine learning model that is configured to create feature vectors from images. The pretrained feature detector model (326) may be pretrained prior to use with training the LiDAR modification system (300). The output of the pretrained feature detector model (326) is a feature vector.

In one or more embodiments, the total loss function (330) is a loss function that includes the vector quantization loss and a loss calculated using the pretrained feature detector model (326). The output of the total loss function (330) is a total loss that may be backpropagated through various models of the LiDAR modification system (300).

The transformer trainer (328) is configured to train the transformer model (310). In one or more embodiments, the transformer trainer (328) is configured to hide portions of the 3D LiDAR image (334) and train the transformer model (310) to predict the codes for the remaining portion. Different training techniques may be used by the transformer trainer, and the particular training technique may be dependent on the type of training performed.

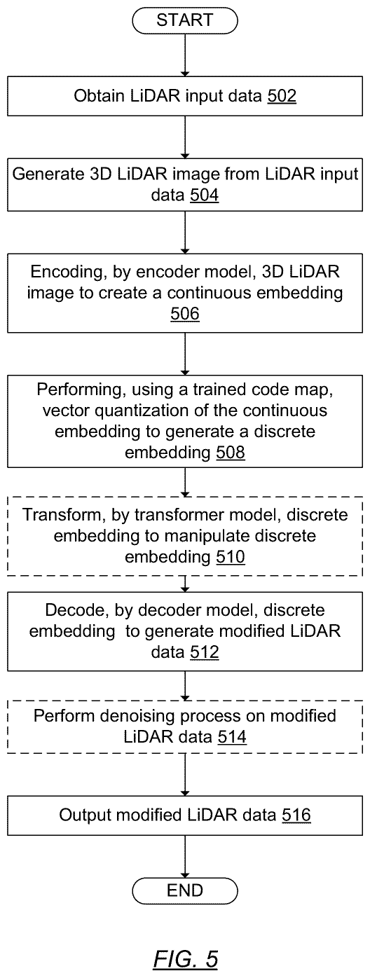

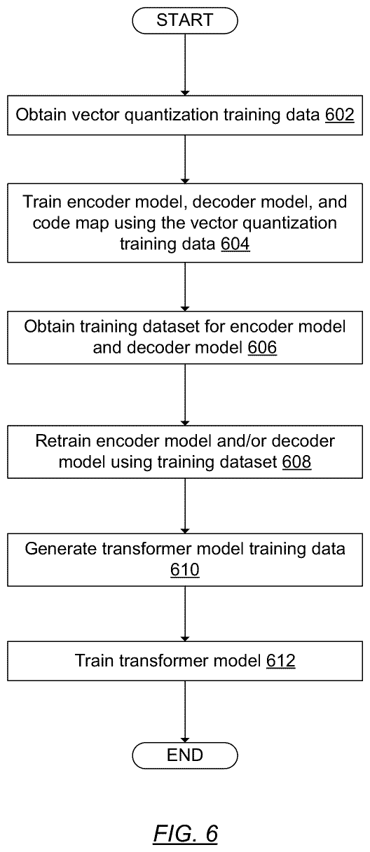

Turning to the flowcharts, FIG. 5 shows a flowchart for modifying LiDAR data by a LiDAR modification system and FIG. 6 shows a flowchart for training the LiDAR modification system. While the various steps in these flowcharts are presented and described sequentially, at least some of the steps may be executed in different orders, may be combined or omitted, and at least some of the steps may be executed in parallel. Furthermore, the steps may be performed actively or passively.

FIG. 5 shows a flowchart for modifying LiDAR data using the LiDAR modification system. Turning to FIG. 5, in Block 502, LiDAR input data is obtained. In the autonomous system, one or more LiDAR sweeps may be performed by one or more real LiDAR sensors. As another example, LiDAR sweeps may be performed by one or more LiDAR sensors that are part of a different system. To perform a LiDAR sweep, the light pulse is transmitted by the LiDAR transmitter of the LiDAR sensor. The light pulse may reflect off of an object, albeit unknown, in the environment, and the time and intensity for the reflected light pulse to return to the receiver is determined. The time is used to determine the distance to an object. The result is a point in a LiDAR point cloud that has distance, an associated direction, and possibly an intensity of the returned light. For the LiDAR sweep, multiple light pulses are transmitted at a variety of angles, and multiple reflected lights are received to obtain multiple points in the LiDAR point cloud. The LiDAR point cloud may be obtained as a list of LiDAR points.

Rather than using a real LiDAR sensor, the simulator, using a sensor simulation model for the LiDAR sensor, may generate simulated LiDAR input data. Specifically, the simulator may generate a scene and render the scene. Machine learning models that are part of the simulator may determine the intensity of the LiDAR points to the various objects in the scene based on the location of the virtual LiDAR sensor in the scene. The relative positions of the virtual LiDAR sensor to the locations of the objects are used to determine the respective distance. The result is a simulated set of LiDAR points that mimic real LiDAR data for a particular simulated scene. The simulated LiDAR data may be of virtually any resolution. For example, the simulated LiDAR data may match the resolution of a real LiDAR sensor. As another example, the simulated LiDAR data may match a desired resolution.

In Block 504, a 3D LiDAR image is generated from the LiDAR input data. In one or more embodiments, a voxelization process is used on the LiDAR input data to generate the 3D LiDAR image. The voxelization process initializes a 3D grid having predefined and configurable resolution, size, scale, and origin location. The initialization may be to set each block to a value of zero or equivalent. The voxelization process may process each point in the LiDAR input data individually. For each point, the voxelization process determines the block of the 3D grid matching the location of the point using the distance and direction of the point to the sensor and the respective origin. The voxelization process then sets the value of the identified block to one. At the end of the voxelization process, blocks in 3D locations that match a LiDAR point in the LiDAR input data have values of one while the remaining blocks have values of zero in one or more embodiments.

In Block 506, the encoder model encodes the 3D LiDAR image to create a continuous embedding of the 3D LiDAR image. The 3D LiDAR image is used directly as input to the encoder model. Specifically, rather than having the third dimension of the input to the encoder model being a feature (e.g., red, blue, green value), the third dimension is a height, and the input is a set of locations in 3D space. The various layers and nodes of the encoder model process the 3D LiDAR image to create a vector embedding in continuous space (i.e., a continuous embedding). The processing by the encoder model is performed using weights learned during the training process described in reference to FIG. 6.

In Block 508, using a trained code map, vector quantization of the continuous embedding is performed to generate the discrete embedding. The vector quantization processes each value in the continuous embedding to determine a matching code for the value. The processing of the value is based on a mapping function that maps ranges of continuous values to corresponding codes as defined by the code map. Thus, each value in the continuous embedding is mapped to a corresponding code to create a value in the discrete embedding. The result of the vector quantization is the discrete embedding.

In Block 510, optionally, a transformer model may transform the discrete embedding to manipulate the discrete embedding. The transformer model may process the codes in the discrete embedding to modify the discrete embedding. The transformer model processes the codes using learned weights through several layers of a transformer machine learning architecture.

In Block 512, the decoder model may decode the discrete embedding to generate modified LiDAR data. Layers of the decoder model may iterate consecutively through the discrete embedding to generate the modified LiDAR data. The weights of the decoder model are learned through the machine learning process. Notably, the modified LiDAR data may have a different resolution, size, or origin than the 3D LiDAR image that is used as input to the encoder model.

In Block 514, a denoising process may be performed on the modified LiDAR data. In one or more embodiments, the denoising process is performed by projecting the modified LiDAR data from 3D space to a range image space to identify a set of obfuscated LiDAR points in the 3D space. For example, the range image space may be of the sensor coordinate where the x y axes are azimuth angle and pitch angle, the value is the depth value. The obfuscated LiDAR points are those points that are in the 3D grid but are not able to be projected into the range image space because closer points are already on the range image space. Namely, the obfuscated points are the points that would be hidden. The set of obfuscated LiDAR points are filtered from the modified LiDAR data. Different denoising techniques may be used to determine the set of obfuscated points that should be filtered.

In Block 516, the modified LiDAR data is outputted. The modified LiDAR data may be outputted to a different component of the autonomous system or the virtual driver. The virtual driver may determine an action of the autonomous system using the modified LiDAR data. As another example, the modified LiDAR data may be generated by the simulator and outputted to another component of the simulator. The simulator modifies a scene for training the virtual driver of the autonomous system. Other components may be a consumer of the modified LiDAR data.

FIG. 6 shows a flowchart for training the LiDAR modification system. In some embodiments, training may be performed in a multi-phase manner In the first phase, the code map is learned, and the encoder models and the decoder models are trained. In the second phase, one or more of the encoder models and the decoder models are retrained. In other embodiments, a single-phase training is performed. For simplicity purposes, the multiphase training is described first. Next, after the discussion of Block 608, single phase training is described.

In Block 602, vector quantization training data is obtained. In one or more embodiments, the vector quantization training data may include one or more training 3D LiDAR images or training LiDAR data that is transformed by a voxelization process to corresponding training 3D LiDAR images. At this phase of the training, the training 3D LiDAR images are defined so that the input to the 3D LiDAR modification system matches the output. For example, if the 3D LiDAR modification system is to perform sparse to dense conversion, both the input and the output are dense LiDAR data. For dense LiDAR training data, the sensor simulation model may generate the dense LiDAR data by simulating more LiDAR rays to a virtual scene. The simulation may be performed as described above with reference to FIG. 5. As another example, real LiDAR data captured by real LiDAR sensors may be used as input when the transformer model is used and trained.

In Block 604, the encoder model, decoder model, and code map are trained using the vector quantization training data. The training is performed by processing the training 3D LiDAR images in the vector quantization training data in the same way as FIG. 5. Specifically, the training 3D LiDAR image is processed by the encoder to generate a training continuous embedding (i.e., a continuous embedding that is for training data). Using an initial code map, the vector quantization of the continuous embedding is performed to generate a training discrete embedding. The decoder model decodes the training discrete embedding to generate reconstructed LiDAR data. The first phase of the training attempts to create the same output as the input.

Based on the output (i.e., the reconstructed LiDAR data), a loss is generated. Calculating the loss may proceed as follows. A vector quantization loss may be calculated as the difference between the reconstructed LiDAR data and the corresponding training 3D image. The difference is calculated as a binary cross entropy loss. A second term of the vector quantization loss is a function of the difference between codes generated using the training 3D image and codes generated using the reconstructed LiDAR data. Specifically, the reconstructed LiDAR data is processed through the encoder model and then through vector quantization. The discrete embedding for the training 3D image previously obtained and the discrete embedding for the reconstructed LiDAR data are compared to generate a comparison result. The result of a function on the comparison result is the second term of the vector quantization loss. The vector quantization loss is thus the combination of the two forms of loss.

The total loss is calculated using the vector quantization loss and the results of a pretrained feature detector model. For example, the feature detector model may generate a first set of features by processing the training 3D LiDAR image. The feature detector model then generates a second set of features from the reconstructed dense LiDAR data. The first set of features is compared to the second set of features to obtain a comparison result. The total loss then includes the comparison result. The total loss is then backpropagated through the decoder model, code map, and encoder model.

In more formal terms, the goal of vector-quantized variational autoencoder (VQ-VAE) is to learn a discrete latent representation that is expressive, robust to noise, and compatible with generative models. As described in reference to FIG. 3, the VQ-VAE includes: (i) an encoder E that encodes the 3D LiDAR image, x∈ [symbol] ^{H×W×3} to a continuous embedding map z=E(x)∈ [symbol] ^{h×w×D}, (ii) an element-wise quantization function q that maps each embedding to its closest learnable latent code eₖ∈ [symbol] ^{D}, with k=1, . . . , K, and (iii) a decoder G that takes as input the quantized representation \hat{z}=q(z) and outputs the reconstructed image \hat{x}=G(\hat{z}). The VQ-VAE model can be trained end-to-end by minimizing:

[symbol]

_{vq}=∥x−\hat{x}∥₂²+∥sg[E(x)]−\hat{z}∥₂²+∥sg[\hat{z}]−E(x)∥₂² (1)

where sg[⋅] denotes the stop-gradient operation and the [symbol] ₂ reconstruction loss is changed to a binary (occupied or not) cross-entropy loss.

The limited number of discrete codes e stabilizes the input distribution of the decoder during training. The limited number of codes also forces the codes to capture meaningful, re-usable information as the decoder can no longer “seek shortcut” from the continuous signals for the reconstruction task. However, directly applying VQ-VAE can be a challenge since the fixed set of discrete latents (i.e., codes) model point clouds that live in a continuous 3D space, and each point cloud may have a different number of points. To address these issues, the point clouds are voxelized in the 3D image, which shows whether each voxel is occupied or not. By grounding the point clouds with a pre-defined 3D grid, the discrete codebook can learn the overall structure rather than the minor 3D positional variations.

With regards to the encoder model E, for large scenes with high resolution, 3D convolution network is computationally expensive since the occupancy of each voxel densely is inferred. One or more embodiments therefore use an encoder model that is a 2D convolutional network whereby the third dimension is height rather than red, green, and blue values. Stated another way, the 3D LiDAR image is processed like a 2D image on the convolutional network encoder model, whereby the height is the feature channel C. In this case, the encoder model processes 3D LiDAR data just like 2D images; and existing model architectures designed for 2D images directly may be exploited as the encoder model. The output of the decoder G is a logit grid \hat{x}∈ [symbol] ^{H×W×C}. The output can be further converted to a binary voxel grid \hat{x}^{bin}∈{0,1}^{H×W×C} through gumbel softmax.

The total loss through the training may be calculated as:

[symbol]

_{feat}= [symbol] _{vq}+∥V_{b}(x)−V_{b}(\hat{x}^{bin})∥₂² (2)

V_{b} denotes the feature from the last backbone layer of V, which is a pre-trained voxel-based detector V. Further, V_{vq} is the loss calculated in equation (1).

In one or more embodiments, the training of the code map is performed as follows. In order to prevent the code map collapse, whereby only a few codes are used, during training, data-dependent codebook initialization is performed. Specifically, a memory bank is used to store the continuous embedding output from the encoders at each iteration; and K-Means centroids of the memory bank are used to initialize/reinitialize the codebook if the code utilization percentage is lower than the utilization threshold. For example, the utilization threshold may be 256 iterations since the last use or fifty percent. Further, through several training iterations, the code map is gradually changed from mapping to continuous space to mapping to discrete space. For example, for the first 2000 iterations of training, the decoder input (i.e., the codes or discrete embeddings) may be gradually shifted from continuous to quantized embeddings as a warmup.

In Block 606, a training dataset is obtained for the encoder model and the decoder model. In one or more embodiments, after the code map is trained and optionally, the decoder model is trained, the encoder model may be further trained. For example, for sparse to dense conversions, the encoder model is retrained to handle sparse 3D LiDAR images. The same form of encoder model may be used, but the training data is different. Further training of the encoder model is optional and may not be used if the LiDAR modification system is to perform a manipulation of the LiDAR data rather than filling in the existing LiDAR data. Obtaining the training dataset for the encoder model and the decoder model may be performed in a similar process to obtaining the vector quantization training data described above.

In Block 608, the encoder model and/or the decoder model are retrained using the training dataset. Given a dataset of paired, voxelized LiDAR point clouds {(x₁^{sp}, x₁^{den}), . . . , (x_{N}^{sp}, x_{N}^{den})}, the goal of LiDAR completion is to learn a function ƒ that maps a sparse LiDAR point cloud x^{sp} to its dense counterpart x^{den}. For sparse to dense conversion, a discrete code map {e₁^{den}, . . . , e_{K}^{den}}, an encoder E^{den}, and a decoder G^{den} for each dense LiDAR point cloud x^{den} are first learned in Block 604 described above. In Block 608, a separate encoder E^{sp} is learned that maps each sparse LiDAR point cloud x^{sp} to the same feature space z^{sp}=E^{sp}(x^{sp}). The same discrete code map may be used to quantize with the dense discrete representation e^{den}. Further, the quantized representation \hat{z}^{sp}=q(z^{sp}) may be decoded with the dense decoder G^{den} trained in Block 604. The result is a densified point cloud \hat{x}^{sp-den}=G^{den}(\hat{z}^{sp}). For example, one or more embodiments freeze, after training in Block 604, the code map and the decoder model. The freezing prevents updates to the code map and the decoder model. While freezing the code map and the decoder model, the encoder model is retrained with one or more training sparse LiDAR image(s) to train the encoder model to be a sparse encoder model. After retraining, the code map and the decoder model may be unfrozen to allow updates.

Although Blocks 602-608 describe a multi-phase training process, a single phase training may be performed. In such embodiments, rather than a two stage training described above, in some embodiments, the sparse encoder Eₛₚ and the dense VQ-VAE model may be jointly trained. The joint training may be performed to allow the model to learn a codebook that is easy to decode, and achieves low quantization error for both encoders Eₛₚ and E_{den}. The same loss function may be used as described above. However, the reconstructed target to which the reconstructed LiDAR image is compared may be a dense point cloud, obtained from paired training data.

Namely, in some embodiments, the training data obtained in Block 602 may be a pair having a training sparse LiDAR data and a corresponding training dense LiDAR data. To obtain the pair, the LiDAR sensor simulation model may simulate the LiDAR sensor using the intrinsics of a real LiDAR sensor to generate the training sparse LiDAR data that has the sparsity that would be captured by the corresponding real LiDAR sensor. Namely, the initial simulation may be to simulate the real LiDAR data that would be captured. The second execution of the LiDAR sensor simulation model may be for the exact same scene as the first execution, but using a desired resolution of the LiDAR sensor. Namely, the second execution simulates the LiDAR sensor if the LiDAR sensor could capture a dense set of LiDAR points from the scene. The result of the two executions is a pair.

To calculate a loss, the training sparse LiDAR data voxelized as an image is processed by the encoder model, then through the vector quantization process, and then the decoder model to obtain a reconstructed training dense LiDAR data. The reconstructed training dense LiDAR data is compared according to the loss function of equation (1) and equation (2) to the simulated dense LiDAR data described above that matches the training sparse LiDAR data. The loss may then be backpropagated as described above.

In Block 610, transformer model training data is generated. Different techniques may be used to train the transformer model. The particular technique used may be dependent on the type of transformer model. In Block 612, the transformer model is trained.

The learned discrete representations can be naturally combined with generative models (i.e., the transformer model).

For unconditional generation, given the learned codebook e and the decoder G, the problem of LiDAR generation can be formulated as code map generation. Instead of directly generating LiDAR point clouds, one or more embodiments first generate discrete code maps in the form of code indices. Then, the indices are mapped to discrete features by querying the code map and decoding them back to LiDAR point clouds with the decoder. A bi-directional self-attention Transformer may be used to iteratively predict the code map. Specifically, starting from a blank canvas, at each iteration, a subset of the predicted codes with top confidence scores are selected, and the canvas is updated accordingly. With the help of the Transformer, context from the whole code map is aggregated and used to predict missing parts based on already predicted codes. In the end, the canvas will be filled with predicted code indices, from which LiDAR point clouds can be decoded.

For conditional generation, the unconditional generation pipeline described above may be modified as follows. Instead of starting the generation process from an empty canvas, a partially filled code map may be used initially. The Transformer model may then predict the rest. For instance, [CAR] codes may be placed at regions of interest, and the transformer model is executed multiple times. Different traffic scenarios may thus be generated with the pre-defined cars untouched. Please refer to supp. material for how we identify the codes.

Free space suppression sampling may be performed as follows. The iterative generation procedure can be viewed as a variant of coarse-to-fine generation. The codes generated during early iterations determine the overall structure, while the codes generated at the end are in charge of fine-grained details. To prevent degenerated results due to LiDAR point clouds being sparse (i.e., a large portion of the scene is represented by the same [BLANK] codes, the following may be performed. Since the [BLANK] codes occur frequently, the Transformer tends to predict the [BLANK] codes with high scores. To prevent mostly [BLANK] codes from resulting, the early generation stages may suppress the generation of [BLANK] codes by setting the probability of the [BLANK] codes to zero. Thus, the transformer model generates meaningful structures in the beginning. Notably, the [BLANK] codes may be identified by looking at the occurrence statistics of all codes across the whole dataset. The top codes may be identified as [BLANK] codes corresponding to unoccupied regions of a LiDAR image.

Iterative denoising may be performed to reduce high-frequency noise (e.g., there might be some floating points in the very far range). To mitigate this issue, one or more embodiments may randomly mask out different regions of the output LiDAR point clouds and re-generate the masked out regions. The intuition is that if a structured region is masked out, the structured region can be recovered through the neighborhood context. However, if the masked region corresponds to pure noise that is irrelevant to the surrounding area, the masked region will likely be removed after multiple trials (since the model cannot infer it from the context).

To performed the training, the discrete embeddings of the training data is generated using the process described above. Then, at each training iteration, we randomly mask out a subset of codes. Finally, the bi-directional Transformer may be used to predict the correct code for those masked regions. The model may be updated using a cross-entropy loss.

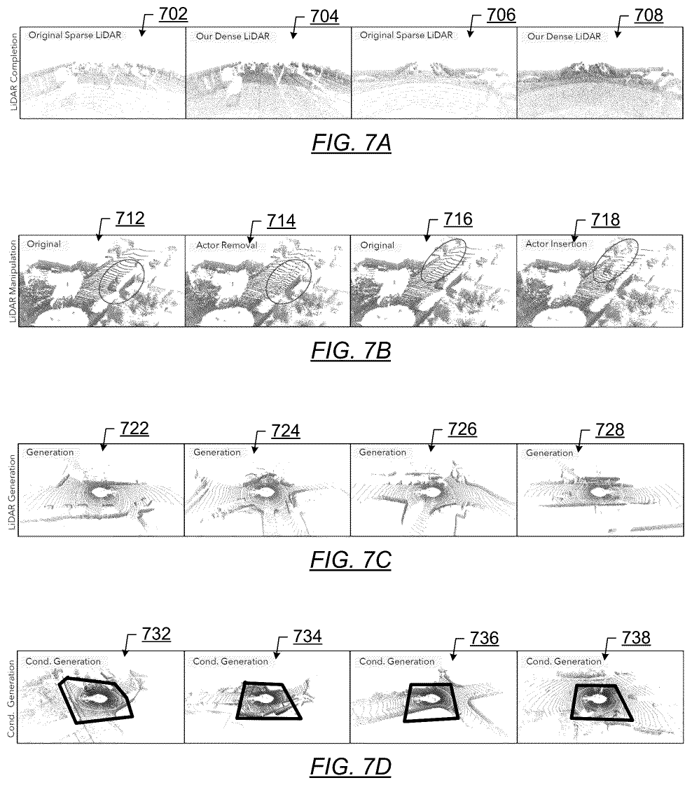

Turning to the example, FIGS. 7A-7D show different examples of different inputs and outputs of the LiDAR modification system. The following examples are for explanatory purposes only and are not intended to limit the scope of the invention.

FIG. 7A shows a first comparison between a sparse LiDAR point cloud (702) and a dense LiDAR point cloud (704) that is generated by embodiments disclosed from the sparse LiDAR point cloud (702). FIG. 7A also shows a second comparison between a sparse LiDAR point cloud (706) and a dense LiDAR point cloud (708) that is generated by embodiments disclosed from the sparse LiDAR point cloud (706). As shown, the dense LiDAR point clouds (704, 708) have far more LiDAR points than the corresponding sparse LiDAR point clouds (702, 706), but also have an accurate representation of the scene.

FIG. 7B shows examples of actor manipulation. As shown in a comparison of an original LiDAR point cloud (712) with the revised LiDAR point cloud (714), the LiDAR points for a particular actor in the original LiDAR point cloud (712) are removed by disclosed embodiments to generate the revised LiDAR point cloud (714). The next example is adding an actor. As shown in a comparison of an original LiDAR point cloud (716) with the revised LiDAR point cloud (718), LiDAR points are added to a blank region of the original LiDAR point cloud (716) by disclosed embodiments to generate the revised LiDAR point cloud (718).

FIG. 7C shows different examples of LiDAR generation. In LiDAR generation, LiDAR scenes (722, 724, 726, 728) are generated with a realistic global structure and fine-grained details.

FIG. 7D shows different examples of conditional LiDAR generation. In conditional LiDAR generation, partially observed LiDAR point clouds are used to generate the remaining portions of the LiDAR scenes (732, 734, 736, 738). The partially observed LiDAR point clouds are the point clouds obtained from actual data and are denoted by the bounding box in the respective figures.

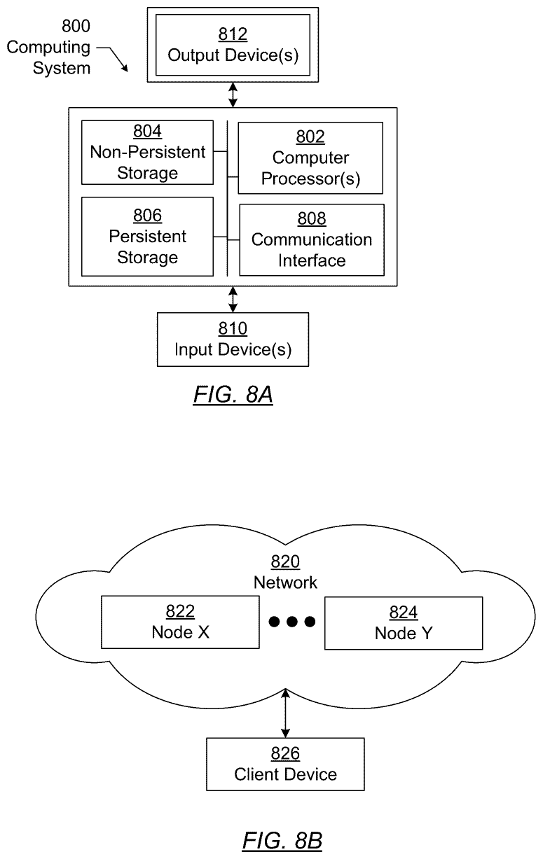

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 8A, the computing system (800) may include one or more computer processors (802), non-persistent storage (804), persistent storage (806), a communication interface (808) (e.g., Bluetooth interface, infrared interface, network interface, optical interface, etc.), and numerous other elements and functionalities that implement the features and elements of the disclosure. The computer processor(s) (802) may be an integrated circuit for processing instructions. The computer processor(s) may be one or more cores or micro-cores of a processor. The computer processor(s) (802) includes one or more processors. The one or more processors may include a central processing unit (CPU), a graphics processing unit (GPU), a tensor processing unit (TPU), combinations thereof, etc.

The input devices (810) may include a touchscreen, keyboard, mouse, microphone, touchpad, electronic pen, or any other type of input device. The input devices (810) may receive inputs from a user that are responsive to data and messages presented by the output devices (812). The inputs may include text input, audio input, video input, etc., which may be processed and transmitted by the computing system (800) in accordance with the disclosure. The communication interface (808) may include an integrated circuit for connecting the computing system (800) to a network (not shown) (e.g., a local area network (LAN), a wide area network (WAN) such as the Internet, mobile network, or any other type of network) and/or to another device, such as another computing device.

Further, the output devices (812) may include a display device, a printer, external storage, or any other output device. One or more of the output devices may be the same or different from the input device(s). The input and output device(s) may be locally or remotely connected to the computer processor(s) (802). Many different types of computing systems exist, and the aforementioned input and output device(s) may take other forms. The output devices (812) may display data and messages that are transmitted and received by the computing system (800). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (800) in FIG. 8A may be connected to or be a part of a network. For example, as shown in FIG. 8B, the network (820) may include multiple nodes (e.g., node X (822), node Y (824)). Each node may correspond to a computing system, such as the computing system shown in FIG. 8A, or a group of nodes combined may correspond to the computing system shown in FIG. 8A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (800) may be located at a remote location and connected to the other elements over a network.

The nodes (e.g., node X (822), node Y (824)) in the network (820) may be configured to provide services for a client device (826), including receiving requests and transmitting responses to the client device (826). For example, the nodes may be part of a cloud computing system. The client device (826) may be a computing system, such as the computing system shown in FIG. 8A. Further, the client device (826) may include and/or perform all or a portion of one or more embodiments.

The computing system of FIG. 8A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
generating a three-dimensional (3D) LiDAR image from LiDAR input data;
encoding, by an encoder model, the 3D LiDAR image to a continuous embedding in continuous space;
performing, using a code map, a vector quantization of the continuous embedding to generate a discrete embedding;
decoding, by a decoder model, the discrete embedding to generate modified LiDAR data; and
outputting the modified LiDAR data.

2. The method of claim 1, further comprising:
transforming, by a transformer model, the discrete embedding to generate a modified vector embedding prior to the decoding, wherein the decoding uses the modified vector embedding.

3. The method of claim 1, wherein the LiDAR input data is sparse LiDAR data and wherein the modified LiDAR data is dense LiDAR data, wherein the encoder model and the decoder model are a sparse to dense converter.

4. The method of claim 1, further comprising:
performing, prior to the outputting, a denoising process on the modified LiDAR data.

5. The method of claim 4, wherein the performing the denoising process comprises:
projecting the modified LiDAR data from 3D space to range image space to identify a set of obfuscated LiDAR points in the 3D space; and
filtering the set of obfuscated LiDAR points from the modified LiDAR data.

6. The method of claim 1, further comprising:
simulating a scene to obtain dense LiDAR data for the scene; and
training the encoder model, the code map, and the decoder model using the dense LiDAR data.

7. The method of claim 6, further comprising:
freezing, after training, the code map and the decoder model; and
retraining, while freezing the code map and the decoder model, the encoder model with a training sparse LiDAR image.

8. The method of claim 6, wherein training the encoder model and decoder model using the dense LiDAR data comprises:
generating a training 3D LiDAR image from the dense LiDAR data;
processing, by the encoder model, the training 3D LiDAR image to generate a training continuous embedding;
performing, using an initial code map, the vector quantization of the continuous embedding to generate a training discrete embedding;
decoding, by the decoder model, the training discrete embedding to generate reconstructed dense LiDAR data; and
generating a loss based on the reconstructed dense LiDAR data.

9. The method of claim 8, further comprising:
generating, by a pretrained feature detector model, a first set of features from the training 3D LiDAR image;
generating, by the pretrained feature detector model, a second set of features from the reconstructed dense LiDAR data; and
comparing the first set of features to the second set of features to obtain a comparison result, wherein the loss comprises the comparison result.

10. The method of claim 1, further comprising:
generating, during training, a binary cross entropy loss as at least a part of a vector quantization loss for training the code map.

11. The method of claim 1, further comprising:
gradually, through several training iterations, changing the code map from mapping to continuous space to mapping to discrete space.

12. The method of claim 1, further comprising:
detecting an unused set of codes that are unused during a training process of learning the code map; and
reactivating the unused set of codes during the training process of learning the code map.

13. The method of claim 12, wherein detecting the unused set of codes comprises:
comparing a usage of a plurality of codes in the code map to a threshold, and
determining a subset of the plurality of codes as unused based on failing to satisfy the threshold to obtain the unused set of codes,
wherein the threshold is on at least one selected from a group consisting of an elapsed time a code is since last used and an amount of continuous space mapped to the code.

14. The method of claim 1, wherein outputting the modified LiDAR data is to a component of a virtual driver of an autonomous system, and wherein the method further comprises:
determining, by the virtual driver, an action of the autonomous system using the modified LiDAR data.

15. The method of claim 1, wherein the LiDAR input data is real sensor data, and wherein the modified LiDAR data is generated by a simulator to modify a scene for training a virtual driver of an autonomous system.

16. A system comprising:
one or more computer processors; and
a non-transitory computer readable medium comprising computer readable program code for causing the one or more computer processors to perform operations comprising:
generating a three-dimensional (3D) LiDAR image from LiDAR input data;
encoding, by an encoder model, the 3D LiDAR image to a continuous embedding in continuous space;
performing, using a code map, a vector quantization of the continuous embedding to generate a discrete embedding;
decoding, by a decoder model, the discrete embedding to generate modified LiDAR data; and
outputting the modified LiDAR data.

17. The system of claim 16, wherein the operations further comprise:
transforming, by a transformer model, the discrete embedding to generate a modified vector embedding prior to the decoding, wherein the decoding uses the modified vector embedding.

18. The system of claim 16, wherein the LiDAR input data is sparse LiDAR data and wherein the modified LiDAR data is dense LiDAR data, wherein the encoder model and the decoder model are a sparse to dense converter.

19. The system of claim 16, wherein the operations further comprise:
performing, prior to the outputting, a denoising process on the modified LiDAR data, wherein the performing the denoising process comprises:
projecting the modified LiDAR data from 3D space to a range image space to identify a set of obfuscated LiDAR points in the 3D space; and
filtering the set of obfuscated LiDAR points from the modified LiDAR data.

20. A non-transitory computer readable medium comprising computer readable program code for causing a computer system to perform operations comprising:
generating a three-dimensional (3D) LiDAR image from LiDAR input data;
encoding, by an encoder model, the 3D LiDAR image to a continuous embedding in continuous space;
performing, using a code map, a vector quantization of the continuous embedding to generate a discrete embedding;
decoding, by a decoder model, the discrete embedding to generate modified LiDAR data; and
outputting the modified LiDAR data.
